(19) United States
(12) Patent Application Publication
(10) Pub. No.: US 2020/0346157 A1
(43) Pub. Date: Nov. 5, 2020

(54) SYSTEM (IN.AIRBOX) FOR PROVIDING A USER WITH HEALTHY AIR

(71) Applicant: Vasyl Ivanovych BURDEINYI, Jr., Zaporizhzhya (UA)

(72) Inventor: Vasyl Ivanovych BURDEINYI, Jr., Zaporizhzhya (UA)

(21) Appl. No.: 16/643,519

(22) PCT Filed: Oct. 3, 2017
(86) PCT No.: PCT/UA2017/000123

§ 371 Date: Feb. 28, 2020

(51) Int. Cl. B01D 46/46; B01D 46/44; F24F 3/16; F24F 11/72; B60H 3/06

(52) U.S. Cl. CPC B01D 46/46; B01D 46/446; B01D 46/448; B01D 46/442; B01D 2279/51; F24F 11/72; B60H 3/06; B01D 2279/40; B01D 2273/30; F24F 3/16

(57) ABSTRACT

The invention relates to air cleaning and enrichment systems, namely, to systems for providing a user with a healthy air, and it may be used in living, training, medical and working rooms, interiors and cabins of vehicles in order to provide household, medical and other people needs in the air that is cleaned from harmful impurities and chemically healthy.

The system “In.AirBox” for providing a user with a healthy air is capable of creating the airflow and comprises a room with at least one means for arranging the user, an air delivery duct, a control device, at least one container comprising the air that is collected in a forest area or in mountains, or over a sea or a seaside, or cleaned from harmful impurities, or comprising added healthy impurities, an air output duct that is coupled to the at least one container comprising the air and that is capable of supplying the air from the at least one container into the room. The air delivery duct is configured with a filter and is capable of supplying the air from the environment into the room that is capable of being closed and equipped with at least one measurement device that is capable of measuring the air pressure and/or temperature, and/or moisture, and/or a number of impurities therein, and coupled to the control device, while the control device is capable of regulating the airflow rate supplied from the air output and delivery ducts depending on parameters of the at least one measurement device.

A technical effect lies in increase of the efficiency, providing safety for the user's health, flexibility, simplicity of use, simplification of the structure, cost-cutting of the air cleaning and enrichment process.

The invention relates to air cleaning and enrichment systems, namely, to systems for providing a user with a healthy air, and it may be used in living, training, medical and working rooms, interiors and cabins of vehicles in order to provide household, medical and other people needs in the air that is cleaned from harmful impurities and chemically healthy.

The current state of the art discloses a method for creating conditions for a long stay of patients suffering from multiple damages of skin covers, receiving an obstetric aid, suffering from pathological complications, in a medical or recovery environment, the method comprising using a system comprising an isolated room, wherein air that comprises harmful components is forcibly passed through a circulation loop of a gas-and-liquid reactor having a form of a bubbling-and-airlifting apparatus with a liquid medium, which provides cleaning of the air from harmful components and discharge thereof, and its feeding with valuable components by performing a technical control of a formulation and a temperature of the isolated room atmosphere (patent RU 2205032 C2, published on May 27, 2003, Bul. No. 15).

Drawbacks of the known analogue lie in its inefficiency, inconvenience of use, limited functionality, complexity of a structure, use and high expenses for the air cleaning.

The inefficiency of the known analogue is caused by the fact that the air is cleaned by passing the same through the circulation loop of the gas-and-liquid reactor that is designed in the form of the bubbling-and-airlifting apparatus with a liquid medium. As such, the bubbling-and-airlifting apparatuses bear a number of significant drawbacks being a low passage rate of a liquid and a gas dissolved therein through said apparatuses, a technical complexity to feed large volumes of the air comprising harmful components to the inner space of said apparatuses, a need in large energy costs for cleaning a small volume of the air, which makes the known analogue too slow and costly, while cleaning small volumes of the air. Furthermore, the inefficiency of the known analogue lies in that the harmful substances, which are separated from the air, in fact remain in the liquid, through which next portions of the air are cleaned, and have a negative impact onto a further cleaning process, while the negative impact of said harmful substances onto the air cleaning and enrichment process may be eliminated only by replacing the liquid in the bubbling-and-airlifting apparatus and its cleaning with special products.

The inconvenience and complexity of use of the known analogue lies in that an increase of a the air volume to be cleaned, an increase of dimensions of the isolated room leads to increase of the volume of the liquid that is required for the cleaning and enrichment of the air and, thus, of the volume of the bubbling-and-airlifting apparatus. In case of using the known analogue in a large-space living room, there is a need in using a corresponding large and too cumbersome gas-and-air reactor with a large circulation loop that creates a problem of its arrangement and maintenance. Furthermore, the process for cleaning and enrichment of the air with healthy substances by passing the same through the liquid in the circulation loop may create a considerable noise in the room that is uncomfortable as well.

The limited functionality of the known analogue lies in that due to use of the cumbersome devices for the air cleaning and enrichment, the application field of the known analogue is limited. The system claimed in the known analogue cannot be used in low-dimension, moving rooms, e.g., in vehicles interiors, in public transport etc.

Use of the known analogue bears high costs, since it requires high-energy costs to clean the air, while the maintenance of the devices comprised in the known analogue requires costs for energy, time, special materials and tools, as well as use of a labor of skilled professionals, which causes high cost of the air cleaning.

There is also known a system for air replacement and positive air pressure isolation, the system comprising a pressure control system within a house, a system inlet, a system outlet, a variable-speed fan, a motor controller that is in communication with the fan and capable of controlling the speed of the fan, an anemometer that is capable of monitoring an air pressure differential between the system inlet and the system outlet, a closed-loop controller that is in communication with the motor controller and with the anemometer, wherein the closed-loop controller is capable of varying the speed of the fan based on the pressure differential between the inlet and outlet of the system, a germicidal radiation chamber having at least one ultraviolet radiation source located within an airflow path in the air-pressure control system, as well as it comprises an air discharge channel that is in communication with the system output and an air supply channel that is in communication with the system inlet (patent US 2013239803 A1, published on Sep. 19, 2013).

Drawbacks of said analogue lie in its inefficiency, harmfulness for a user's health, limited functionality, complexity of a structure and high expenses for the air cleaning.

The inefficiency of the known analogue is caused by the fact that its use almost does not improve a chemical formulation of the air and does not enrich the air with components being healthy for the user, while merely cleaning the same from harmful microorganisms and gaseous products of the user's metabolism. The chemical formulation of the air that passes through the known analogue remains unchanged and does not make a significant impact onto the user's health.

Health harmfulness of the known analogue is caused by the fact that the germicidal radiation chamber is used for cleaning the air, the chamber comprising at least one powerful ultraviolet radiation source. Arrangement of said ultraviolet radiation source in the room with the user of the known analogue located therein for a long time is harmful for the user's health, while prevention of negative effects, which occur during operation of the germicidal radiation chamber of the known analogue, requires an additional shielding of the above-mentioned chamber and the pressure control system, which is costly.

The limited functionality of the known analogue lies in that it is not able to provide satisfaction of individual needs or preferences of the user in terms of moisture, temperature, smell or other properties of the air, since it does not comprise any tools to regulate parameters of the air cleaning, which could be set according to needs of a specific user.

Use of the known analogue bears high costs, since it requires high-energy costs to clean the air, while the maintenance of the devices comprised in the known analogue requires costs for energy, time, special materials and tools, which leads to high costs for the air cleaning. Furthermore, the known analogue is complex in terms of the structure, since it comprises structurally complex electronic devices, as well as a plurality of other structurally complex elements, which also cause high labor and material costs for mounting the known analogue in the room.

The closest analogue of the claimed invention is a system for subjecting users to an air medium enriched with volatile biologically active substances, the system being capable of creating an airflow and including a room having at least one means for arranging the user, an air delivery duct that is in communication with elements for supplying the air to containers with plants, an air discharge duct, a device for creating an airflow that is in communication with the air delivery and discharge ducts, an airflow generator that is in communication with an input of the air discharge duct and that is capable of sucking the air from a part of the room, wherein the containers with plants are located, and of supplying to a part, wherein the at least one means for arranging the user is located, and a control device connected to the device for creating the airflow and to the airflow generator (patent UA 14765 A, published on Jun. 30, 1997, Bul. No. 3).

Drawbacks of the closest analogue lie in inefficiency, harmfulness for the health, limited functionality, complexity of a structure, complexity of use and high expenses for the air cleaning.

The inefficiency of the closest analogue and its harmfulness for a health are caused by the fact that due to its operation, in fact the same air in the same volume circulates in the system, the air being already present in the room and is not restored by supplying air from outside the system or by supplying a new air by the system means. Since the above-mentioned air volume is not cleaned by the means of the closest analogue, is not discharged beyond the system in any way, dust, moisture, harmful microorganisms and harmful substances, first of all, gaseous products of plants and users metabolism, are accumulated in the air. The subsequent circulation of this air comprising said components is harmful both for the users and for the plants arranged in containers. Furthermore, the closest analogue is ineffective and harmful for the health, since the created airflow comprises finest particles of the plants, which may cause allergic reactions in the users of the system.

The limited functionality of the closest analogue is caused by the fact that the system embodiment claimed in the closest analogue does not imply any elements, which could be provided for enrichment of the air with biologically active components or chemical substances, which are different from the ones that are evolved by the plants located in the room. The absence of said elements makes it impossible to set the closest analogue for users having various preferences or medical needs, or causes replacement of the containers with the plants to other ones that is inconvenient and cost-effective. Furthermore, the closest analogue has a limited functionality, since the arrangement of the containers with the plants in the room, presence of the complex air-circulation system that consists of a plurality of elements result in that it cannot be used in personal and public transport, small-space rooms and the like.

The increased complexity of the structure of the closest analogue, the complexity of use thereof and its high cost for cleaning the air are caused by the presence of a plurality of elements, which are structurally complex and difficult in maintenance, which correct operation requires high costs of energy, labor and materials. Meanwhile, the presence of the containers with live plants in the room causes a need in observance of the plants, costs for fertilizers, irrigation, warming the plants, which is costly and, thus, makes the air cleaning more expensive.

A technical task of the claimed invention lies in a creation of a novel system for providing a user with a healthy air, the system is characterized by an increased efficiency, safety for the user's health, flexibility, simplicity of use, simplified structure and cost-cutting of the air cleaning and enrichment process.

A solution of the stated technical task is achieved by that a system “In.AirBox” for providing a user with a healthy air, the system is capable of creating an airflow and comprises a room with at least one means for arranging the user, an air delivery duct, a control device, according to the proposal, comprises at least one container comprising the healthy air that is collected in a forest area or in mountains, or over a sea or a seaside, or cleaned from harmful impurities, or comprising added healthy impurities, an air output duct that is coupled to the at least one container comprising the air and that is capable of supplying the air from the at least one container into the room, the air delivery duct is configured with a filter and is capable of supplying the air from the environment into the room that is capable of being closed and equipped with at least one measurement device that is capable of measuring the air pressure and/or temperature, and/or moisture, and/or a number of impurities therein, and/or other, and coupled to the control device, while the control device is capable of regulating the airflow rate supplied through the air output and delivery ducts depending on parameters of the at least one measurement device.

Also, according to the proposal, the air output duct is capable of supplying the air from the at least one container into the room through the air delivery duct.

Furthermore, according to the proposal, the air delivery duct is capable of delivering the air from the environment through a ventilation system or a conditioning system.

Furthermore, according to the proposal, the system comprises an air discharge duct that is capable of discharging the air outside from the room.

At the same time, according to the proposal, the system comprises an additional air duct that is capable of supplying flavoring agents and/or phytoncides, and/or drugs, and/or other into the room.

Also, according to the proposal, the air delivery duct and the air output duct are provided with fans.

Furthermore, according to the proposal, the air output duct is capable of supplying the air directly to the user arranged in the corresponding means for arranging the user.

Furthermore, according to the proposal, the room is a medical or training room, or a vehicle interior, or a vehicle cabin, or a living room, or a compartment of a railway transport, or an interior space of a subway car or a plane interior, or other.

At the same time, according to the proposal, the air output duct is coupled to the room conditioning system or to the room ventilation system.

Furthermore, according to the proposal, the room comprises a medical diagnostic equipment.

A technical effect of the claimed invention lies in increase of the efficiency, providing safety for the user's health, flexibility, simplicity of use, simplification of the structure, cost-cutting of the air cleaning and enrichment process.

A cause-and-effect relationship between the essential features of the invention and the expected technical effect lies in the following.

The set of the essential features of the claimed invention provides increase of the efficiency of the claimed system for providing the user with the valuable air due to the fact that the system comprises a source of the healthy air and enables to replace the air in the room, safety for the user due to provision of cleanliness and valuable properties of the air supplied into the room, flexibility due to designing the system as being capable of selecting or setting properties of the air supplied into the room according to needs of a specific user and enabling to use the claimed system in any room, simplification of the structure and cost-cutting of the air cleaning and enrichment process due to the fact that the claimed system does not comprise structurally complex elements, which require a complex and cost-effective technical maintenance, high costs for energy, materials, time and labor.

The fact that the system comprises the at least one container comprising the air that is collected in a forest area or in mountains, or over a sea or a seaside, or cleaned from harmful impurities, or comprising added healthy impurities, as well as the air output duct that is coupled to the at least container comprising the air and capable of supplying the air from the at least one container into the room increases the efficiency of the claimed system and provides its safety for the user's health, since it enables to supply, to the room, the air that makes a positive impact onto the user's health, does not comprise harmful components and gradually replaces the air with the increased content of the gaseous products of the user's metabolism, e.g., carbon dioxide, with the fresh air from the container. Furthermore, presence of the above-mentioned elements of the system provides the system's flexibility, since it enables to fill the room with the air having a chemical formulation and other properties, which correspond to the needs and preferences of a specific user, as well as enables to use the claimed system in rooms of any size, including in vehicle interiors and cabins, and in the public transport.

The design of the claimed system with the air delivery duct that is configured with the filter and is capable of supplying the air from the environment into the room that is capable of being closed increases the efficiency of the claimed system and provides its safety for the user's health, since it enables to supply, to the room, any air volume that is necessary for the user to breath by regulating the room pressure, air temperature, a ratio between the air supplied from the container and the air that already fills the room. Due to the fact that the room is capable of being closed, the air supplied into the room from the container and the air supplied into the room through the air delivery duct do not dissipate and stay in the room at an optimal ratio and concentration.

The fact that the claimed system comprises the room equipped with the at least one measurement device that is capable of measuring the air pressure and/or temperature, and/or moisture, and/or a number of impurities therein, and/or other, and coupled to the control device, as well as the fact that the control device is capable of regulating the airflow rate from the air output and delivery ducts depending on parameters of the at least one measurement device, increases the efficiency of the claimed system and provides its safety for the user's health, since it enables to set the system in such a way so that it could operate as much effective and helpful as possible as dependent on the user's needs, his/her health condition, individual preferences, functional purpose of the room etc. At the same time, the flexibility of the claimed system is provided, since the fact that the system comprises the above-mentioned elements enables to use it for any rooms and any users by regulating the system settings by means of the control device and being guided by the parameters of the at least one measurement device also simplifies the use of the claimed system.

Therewith, the claimed system does not comprise elements, which are complex in terms of a structure, a manufacturing method, coupling method, which operation requires high costs of energy, time, complex technical equipment, valuable materials, that makes the claimed system simple in use, simplifies its structure and cost-cuts the air cleaning and enrichment process.

The fact that the air output duct is capable of supplying the air from the at least one container into the room through the air delivery duct simplifies the structure of the claimed system, as well as enables the user to control the flow rates from the both of air ducts at the same time that is convenient.

The fact that the air delivery duct is capable of delivering the air from the environment through the ventilation system or the conditioning system allows to reduce costs for mounting and setting the claimed system, to simplify its structure and to integrate the claimed system into the already existing room by coupling to the corresponding systems. Therewith, the flexibility of the system is provided, since said design of the air delivery duct enables to expand the functions of the claimed system due to the functions of the ventilation system or the conditioning system.

The fact that the claimed system is configured with the air discharge duct that is capable of discharging the air outside the room increases the efficiency of the claimed system and provides its safety for the user's health, since it enables to discharge, from the room, the air that is saturated with gaseous products of the user's metabolism, e.g., carbon dioxide, and to maintain the air in the room in the healthy condition for the user's health, thereby providing a continuous supply of the fresh air instead of the air that has been discharged outside the room.

The fact that the claimed system comprises the additional air duct that is capable of supplying flavoring agents and/or phytoncides, and/or drugs, and/or other into the room increases the efficiency of the claimed system and provides its flexibility, since it enables to make a positive impact onto a patient's health due to valuable impurities, which are not comprised in the air formulation in the container, as well as to expand the range of the system users due to expansion of the functions of the system and the formulation of the valuable chemical components, which are supplied into the room.

The fact that the air delivery duct and the air output duct are provided with the fans enables to speed up the air supply into the room that increases the efficiency of the claimed system.

The fact that the air output duct is capable of supplying the air directly to the user arranged in the corresponding means for arranging the user increases the efficiency of the claimed system and simplifies its use, since it enables to supply the air from the air output duct to the user prior to its dissipation within the room, as well as enables the user, if necessary, to breath with the air that is directly supplied from the air output duct.

The fact that the room comprises the medical diagnostic equipment provides the flexibility of the claimed system, since it allows to use the claimed system for medical purposes with consideration of a revealed diagnosis, a method for treating the user, his/her physical condition etc.

The structure and the operation principle of the claimed system for providing the user with the healthy air are explained with the following drawing:

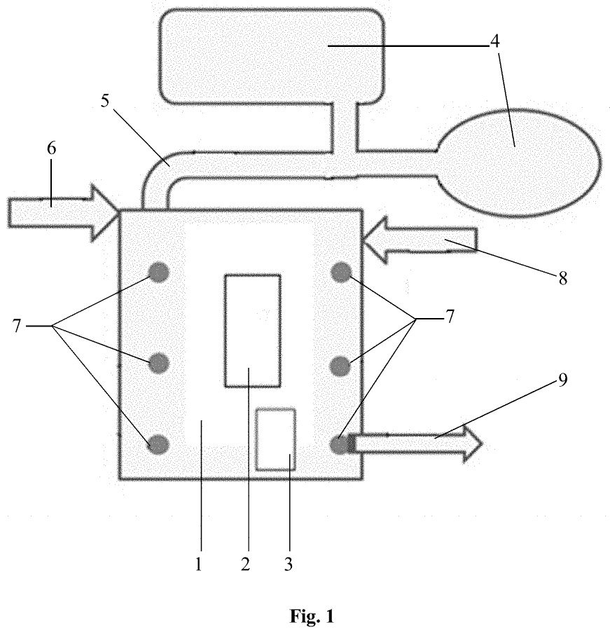

FIG. 1—a schematic illustration of the system for providing the user with the healthy air.

FIG. 1 schematically depicts one of possible, but not exclusive embodiment of the claimed system for providing a user with a healthy air, which do not limit the embodiments, the system comprising a room 1 with one means 2 for arranging the user, an air delivery duct 6, a control device 3, two containers 4, an air output duct 5. In the depicted embodiment, the room 1 of the claimed system is equipped with six measurement devices 7, and the claimed system is configured with an additional air duct 8 and an air discharge duct 9.

The room 1 is capable of being closed and equipped with at least one measurement device 7 and comprises at least one means 2 for arranging the user. For example, the room may be a medical or training room, or a vehicle interior, or a vehicle cabin, or a living room, or a compartment of a railway transport, or an interior space of a subway car or a plane interior, or other similar room. Also, the room 1 may comprise a medical diagnostic equipment.

The means 2 for arranging the user is intended for a comfortable user's stay in the room 1 and may be, e.g., an armchair, a training device, a bed, a bathroom etc.

The control device 3 is connected to the at least one measurement device 7 and is capable of regulating the airflow rate from the air output duct 5 and the air delivery duct 6 depending on parameters of the at least one measurement device 7. For example, such control device may be a control board, a computer having a specially configured software installed thereon and other similar devices.

The containers 4 comprise an air collected that is collected in a forest area or in mountains, or over a sea or a seaside, or cleaned from harmful impurities, or comprising added healthy impurities, and are coupled to the air output duct 5. For example, such containers may be gas tanks having means, which enable to output the air from said tanks gradually.

The air output duct 5 is coupled to the at least one container 4 and is capable of supplying the air from the at least one container 4 into the room 1. The air output duct 5 may be capable of supplying the air from the at least one container 4 into the room 1 through the air delivery duct 6, of supplying the air directly to the user arranged in the corresponding means 2 for arranging the user, as well as it may be coupled to a room conditioning system or to a room ventilation system and comprise a fan or another similar device for enhancing the airflow.

The air delivery duct 6 is configured with a filter and is capable of supplying the air from the environment into the room 1, it may be capable of delivering the air from the environment through the ventilation system or the conditioning system and it may comprise a fan.

The measurement devices 7 are capable of measuring the air pressure and/or temperature, and/or moisture, and/or a number of impurities therein, and/or other, and coupled to the control device 3. For example, such measurement devices may be electronic thermometers, anemometers, barometers, hygrometers, gas analyzers and other similar devices. The measurement devices 7 may be connected to the control device 3 by means of a wired and a wireless communication.

The additional air duct 8 comprised in the depicted embodiment is capable of supplying flavoring agents and/or phytoncides, and/or drugs, and/or other into the room 1 and it may comprise a container with flavoring agents, phytoncides, drugs or a mixture thereof, as well as a device for burning, dissipating, evaporating or supplying thereof into the room 1 in another way.

In the preferred embodiment, the claimed system for providing the user with the healthy air comprises the air discharge duct 9 that is capable of discharging the air outside the room 1.

The claimed system for providing the user with the healthy air is used as follows.

The user, when located in the room 1, closes it and, upon arrangement in the means 2 for arranging the user, sets the claimed system according to his/her own needs and preferences by means of the control device 3 by triggering the air supply from the containers 4, regulating the airflow rate from the air output duct 5 and the air delivery duct 6, turning on the fans, if any, to supply the air to the air discharge duct 9 or to supply flavoring agents, phytoncides, drugs from the additional air duct 8 etc.

Then, the airflow from the containers 4 is supplied into the room 1 through the air output duct 5 and from the environment through the filter of the air delivery duct 6. The user is located in the room 1 when driving a vehicle, doing training exercises, taking drugs or making other actions in accordance with a type of the room 1 and breaths the air supplied from the air ducts of the system.

If parameters of the air supply must be changed or the claimed system must be turned off, the user, by means of the control device 3, introduces the corresponding changes into the parameters of the air supply or terminates the air supply from the air ducts into the room 1, e.g., by shutting off the air delivery duct 6 and the air output duct 5, by shutting off the outputs.

Therefore, the claimed system for providing the user with the healthy air is simple in use, does not require a complex technical maintenance, does not comprise expensive and complex elements that causes its low cost and absence of necessity in high costs for the air cleaning and enrichment. Due to its flexibility, the claimed system may be used to satisfy domestic needs only and for medical, scientific, sporting purposes, which makes it an instrument for cleaning, sanitation and enrichment of the air aimed at a wide range of consumers. At the same time, the claimed system makes a significant valuable impact onto the user's health without any side effects, inconveniences or delays for cleaning a huge amount of the air from the containers 4 etc.

The claimed system for providing the user with the healthy air having the claimed set of essential features has not been revealed in the existing sources of patent and scientific technical information, thus, the proposed technical solution meets the criteria of “novelty”.

The proposed technical solution is industrially applicable, since it does not comprise any structural elements and materials, which could not be reproduced at the current stage of the technical development.

1. A system “In.AirBox” for providing a user with a healthy air, the system is capable of creating an airflow and comprises a room with at least one means for arranging the user, an air delivery duct, a control device, characterized in that it comprises at least one container that comprises the healthy air that is collected in a forest area or in mountains, or over a sea or a seaside, or cleaned from harmful impurities, or comprising added healthy impurities, an air output duct that is coupled to the at least one container comprising the air and that is capable of supplying the air from the at least one container into the room, the air delivery duct is configured with a filter and is capable of supplying the air from the environment into the room that is capable of being closed and equipped with at least one measurement device that is capable of measuring the air pressure and/or temperature, and/or moisture, and/or a number of impurities therein, and/or other, and coupled to the control device, while the control device is capable of regulating the airflow rate supplied through the air output and delivery ducts depending on parameters of the at least one measurement device.

2. The system “In.AirBox” for providing a user with a healthy air according to claim 1, characterized in that the air output duct is capable of supplying the air from the at least one container into the room through the air delivery duct.

3. The system “In.AirBox” for providing a user with a healthy air according to claim 1, characterized in that the air delivery duct is capable of delivering the air from the environment through a ventilation system or a conditioning system.

4. The system “In.AirBox” for providing a user with a healthy air according to claim 1, characterized in that it comprises an air discharge duct that is capable of discharging the air outside from the room.

5. The system “In.AirBox” for providing a user with a healthy air according to claim 1, characterized in that it comprises an additional air duct that is capable of supplying flavoring agents and/or phytoncides, and/or drugs, and/or other into the room.

6. The system “In.AirBox” for providing a user with a healthy air according to claim 1, characterized in that the air delivery duct and the air output duct are provided with fans.

7. The system “In.AirBox” for providing a user with a healthy air according to claim 1, characterized in that the air output duct is capable of supplying the air directly to the user arranged in the corresponding means for arranging the user.

8. The system “In.AirBox” for providing a user with a healthy air according to claim 1, characterized in that the room is a medical or training room, or a vehicle interior, or a vehicle cabin, or a living room, or a compartment of a railway transport, or an interior space of a subway car or a plane interior, or other.

9. The system “In.AirBox” for providing a user with a healthy air according to claim 1, characterized in that the air output duct is coupled to the room conditioning system or to the room ventilation system.

10. The system “In.AirBox” for providing a user with a healthy air according to claim 1, characterized in that the room comprises a medical diagnostic equipment.
